(19) United States
(12) Patent Application Publication
(10) Pub. No.: US 2022/0400137 A1
(43) Pub. Date: Dec. 15, 2022

(54) WIDGET DISPLAY METHOD AND APPARATUS

(71) Applicant: BEIJING DAJIA INTERNET INFORMATION TECHNOLOGY CO., LTD., Beijing (CN)

(72) Inventor: Yong DUAN, Beijing (CN)

(21) Appl. No.: 17/821,921

(22) Filed: Aug. 24, 2022

Related U.S. Application Data
(63) Continuation of application No. PCT/CN2021/076334, filed on Feb. 9, 2021.

(30) Foreign Application Priority Data
Feb. 28, 2020 (CN) 202010131222.2

(51) Int. Cl. H04L 65/1089; G06F 3/0484; H04L 65/403; H04N 7/14

(52) U.S. Cl. CPC H04L 65/1089; G06F 3/0484; H04L 65/403; H04N 7/147

(57) ABSTRACT

The present disclosure relates to the technical field of computers, and in particular to a widget display method and apparatus, an electronic device and a computer-readable storage medium. The widget display method applied to a live streaming server comprises: determining a target widget required for display; generating a widget display request on the basis of widget information of the target widget and an area identifier used for indicating a widget display position; and sending the widget display request to a designated client having a live broadcast interface enabled, such that the designated client displays the target widget corresponding to the widget information in an designated display area in the live broadcast interface, thereby relieving the service processing pressure of the client.

### CROSS REFERENCE TO RELATED APPLICATION

The present disclosure is a Continuation Application of PCT International Application No. PCT/CN2021/076334 filed on Feb. 9, 2021, which claims priority to Chinese patent application No. 202010131222.2 filed on Feb. 28, 2020, the entire contents of both are incorporated herein by reference in their entireties.

### TECHNICAL FIELD

The present disclosure relates to the field of computer technology, and in particular, to a widget display method, apparatus, electronic device, and computer-readable storage medium.

### BACKGROUND

Among the related technologies involved in live streaming, more and more service widgets need to be displayed in the live streaming room. However, the widget display logic, such as display position and display priority, of different service widgets is mainly controlled by the client receiving service signaling, for processing the display logic about a complete set of service widgets.

### SUMMARY

Some embodiments of the present disclosure provide a widget display method, which is applied to a live streaming server. The method includes: determining a target widget required for display; generating a widget display request based on widget information of the target widget and an area identifier for indicating a widget display position, where the area identifier corresponds to at least one display area included in a live streaming interface; and sending the widget display request to a designated client with the live streaming interface enabled, so that the designated client displays the target widget corresponding to the widget information in a designated display area of the live streaming interface, where the designated display area corresponds to the area identifier.

In some embodiments, the determining the target widget required for display includes: receiving a live streaming room entry request, where the live streaming room entry request carries a live streaming room identifier and a user identifier; and determining the target widget according to the live streaming room identifier and the user identifier.

In some embodiments, the determining the target widget according to the live streaming room identifier and the user identifier includes: calling live streaming room widget information corresponding to the live streaming room identifier and widget configuration information corresponding to the user identifier; and selecting widget information corresponding to the widget configuration information from the live streaming room widget information, and selecting a widget corresponding to the widget information as the target widget.

In some embodiments, if the target widget is a widget to be changed that has been sent to the designated client but needs to be changed in widget information, the generating the widget display request based on the widget information of the target widget and the area identifier for indicating the widget display position, includes: generating the widget display request based on the widget information of the target widget, the area identifier for indicating the widget display position, and a preset update identifier for representing a widget change.

In some embodiments, the widget information at least includes the widget identifier and at least one of widget position information for widget storage, widget display priority information and widget display time.

In some embodiments, the method further includes: in response to an interface division operation initiated based on the live streaming interface, obtaining a plurality of display areas for widget display by dividing the live streaming interface; adding an area identifier to each display area, and storing the display area with the area identifier added in association with the area identifier; and generating interface area information based on the display area and the area identifier saved in association with each other, and sending the interface area information to a client with the live streaming interface enabled.

Some embodiments of the present disclosure provide a widget display method, which is applied to a client. The method includes: receiving a widget display request sent by a live streaming server, where the widget display request carries widget information and an area identifier, and the area identifier corresponds to at least one display area included in the live streaming interface; determining a target widget to be displayed according to the widget information, and determining a designated display position of the target widget in a live streaming interface according to the area identifier; and displaying the target widget in the live streaming interface based on the designated display position.

In some embodiments, the determining the target widget according to the widget information includes: in response to the widget information including at least a widget identifier and widget position information for widget storage, acquiring a target widget corresponding to the widget identifier at a designated position corresponding to the widget position information.

In some embodiments, the method further includes: in response to the widget display request does not contain a preset update identifier for representing a widget update, determining the target widget according to the widget information, and determining the designated display position of the target widget in the live streaming interface according to the area identifier.

In some embodiments, the method further includes: in response to the widget display request including the preset update identifier, determining a widget to be updated according to the widget information and the preset update identifier; and updating the widget corresponding to the widget information according to the widget to be updated, and selecting the updated widget as the target widget.

In some embodiments, the method further includes: in response to a live streaming room entry operation initiated by a user, sending a live streaming room entry request carrying the user identifier and the live streaming room identifier of the live streaming room to be entered to the live streaming server, so that the live streaming server generates the widget display request based on the user identifier and the live streaming room identifier.

In some embodiments, the method further includes: in response to the received widget display request including no widget information, performing a widget display disable operation for each widget displayed in the live streaming interface.

In some embodiments, the method further includes: receiving the interface area information sent by the live streaming server, where the interface area information includes the display area and the area identifier saved in association with each other; and saving the interface area information.

Some embodiments of the present disclosure provide a widget display apparatus, which is applied to a live streaming server. The apparatus includes: a widget determination module, configured to determine a target widget to be displayed; a display request generation module, configured to generate a widget display request based on the widget information of the target widget and an area identifier for indicating the widget display position, the area identifier corresponding to at least one display area included in a live streaming interface; and a display request sending module, configured to send the widget display request to a designated client with the live streaming interface enabled, so that the designated client displays the target widget corresponding to the widget information in the designated display area of the live streaming interface, where the designated display area corresponds to the area identifier.

In some embodiments, the widget determination module includes: an entry request receiving unit, configured to receive a live streaming room entry request, where the live streaming room entry request carries a live streaming room identifier and a user identifier; and a widget determination unit, configured to determine the target widget according to the live streaming room identifier and the user identifier.

In some embodiments, the widget determination unit includes: an information calling subunit, configured to call the live streaming room widget information corresponding to the live streaming room identifier and the widget configuration information corresponding to the user identifier; and a widget selection subunit, configured to select widget information corresponding to the widget configuration information from the live streaming room widget information, and select the widget corresponding to the widget information as the target widget.

In some embodiments, if the target widget is a widget to be changed that has been sent to the designated client but needs to be changed in widget information, the display request generation module is further configured to generate the widget display request based on the widget information of the target widget, an area identifier for indicating a widget display position, and a preset update identifier for representing a widget change.

In some embodiments, the widget information at least includes a widget identifier and at least one of widget position information for widget storage, widget display priority information and widget display time.

In some embodiments, the apparatus further includes: an operation response module, configured to, in response to an interface division operation initiated based on the live streaming interface, obtaining a plurality of display areas for display of widgets by dividing the live streaming interface; an area information saving module, configured to add an area identifier to each display area, and to save the display area with the area identifier added in association with the area identifier; and an area information sending module, configured to generate interface area information based on the display area and the area identifier saved in association with each other, and send the interface area information to the client with the live streaming interface enabled.

Some embodiments of the present disclosure provide a widget display apparatus, which is applied to a client. The apparatus includes: a display request receiving module, configured to receive a widget display request sent by the live streaming server, where the widget display request carries widget information and an area identifier, and the area identifier corresponds to at least one display area included in the live streaming interface; a display information determination module, configured to determine a target widget to be displayed according to the widget information, and determine a designated display position of the target widget in the live streaming interface according to the area identifier; and a widget display module, configured to display the target widget in the live streaming interface based on the designated display position.

In some embodiments, the display information determination module is specifically configured to, in the case that the widget information includes at least a widget identifier and widget position information for widget storage, acquire the target widget corresponding to the widget identifier at a designated position corresponding to the widget position information.

In some embodiments, the apparatus further includes an update identification detection module. The update identification detection module includes: a identification detection unit, configured to, in the case that the widget display request does not contain a preset update identifier for representing a widget update, determine the target widget according to the widget information, and determine the designated display position of the target widget in the live streaming interface.

In some embodiments, the update identification detection module further includes: an update information acquisition unit, configured to determine a widget to be updated according to the widget information and the preset update identifier in the case that the preset update identifier is included in the widget display request; and a widget update unit, configured to update the widget corresponding to the widget information according to the widget to be updated, and select the updated widget as the target widget.

In some embodiments, the apparatus further includes: an entry request sending module, configured to, in response to a live streaming room entry operation initiated by a user, send a live streaming room entry request carrying the user identifier and the live streaming room identifier of the live streaming room to be entered to the live streaming server, so that the live streaming server generates the widget display request based on the user identifier and the live streaming room identifier.

In some embodiments, the apparatus further includes: a display disable module, configured to perform a display disable operation for each widget displayed in the live streaming interface if the received widget display request does not contain widget information.

In some embodiments, the apparatus further includes: an area information receiving module, configured to receive the interface area information sent by the live streaming server, where the interface area information includes the display area and the area identifier stored in association with each other; and save the interface area information.

Some embodiments of the present disclosure provide an electronic device comprising: a processor; and a memory, configured to store instructions executable by the processor. The processor is configured to execute the instructions, so as to perform the above widget display method.

Some embodiments of the present disclosure provide a computer-readable storage medium. When instructions in the storage medium are executed by a processor in an electronic device, the electronic device is caused to perform the above-described widget display method.

Some embodiments of the present disclosure provide a computer program product, comprising at least one non-transitory computer-readable medium configured to store instructions translatable by at least one processor, for performing the aforementioned widget display device.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of the present specification, illustrate embodiments consistent with the present disclosure, and together with the present description, serve to explain the principle of the present disclosure and do not unduly limit the present disclosure.

FIG. 1 is a schematic diagram of an application scenario of a widget display method according to an exemplary embodiment.

FIG. 2 is a flow chart of a widget display method applied to a live streaming server according to an exemplary embodiment.

FIG. 3 is a flow chart of another widget display method applied to a live streaming server according to an exemplary embodiment.

FIG. 4 is a schematic interface diagram of a live streaming interface with multiple display areas according to an exemplary embodiment.

FIG. 5 is a flowchart of a widget display method applied to a client according to an exemplary embodiment.

FIG. 6 is a flow chart of another widget display method applied to a client according to an exemplary embodiment.

FIG. 7 is a block diagram of a widget display apparatus applied to a live streaming server according to an exemplary embodiment.

FIG. 8 is a block diagram of a widget display apparatus applied to a client according to an exemplary embodiment.

FIG. 9 is a block diagram of an electronic device according to an exemplary embodiment.

### DETAILED DESCRIPTION OF THE EMBODIMENTS

In order to make those skilled in the art better understand the technical solutions of the present disclosure, the technical solutions in embodiments of the present disclosure will be clearly and completely described below with reference to the accompanying drawings.

It should be noted that the terms “first”, “second” and the like in the description and claims of the present disclosure and the above drawings are used to distinguish similar objects, and are not necessarily used to describe a specific sequence or order. It is to be understood that the data so used may be interchanged under appropriate circumstances, so that embodiments of the present disclosure described herein can be practiced in sequences other than those illustrated or described herein. The implementations described in the illustrative examples below are not intended to represent all implementations consistent with the present disclosure. Rather, they are merely examples of means and devices consistent with some aspects of the present disclosure, as recited in the appended claims.

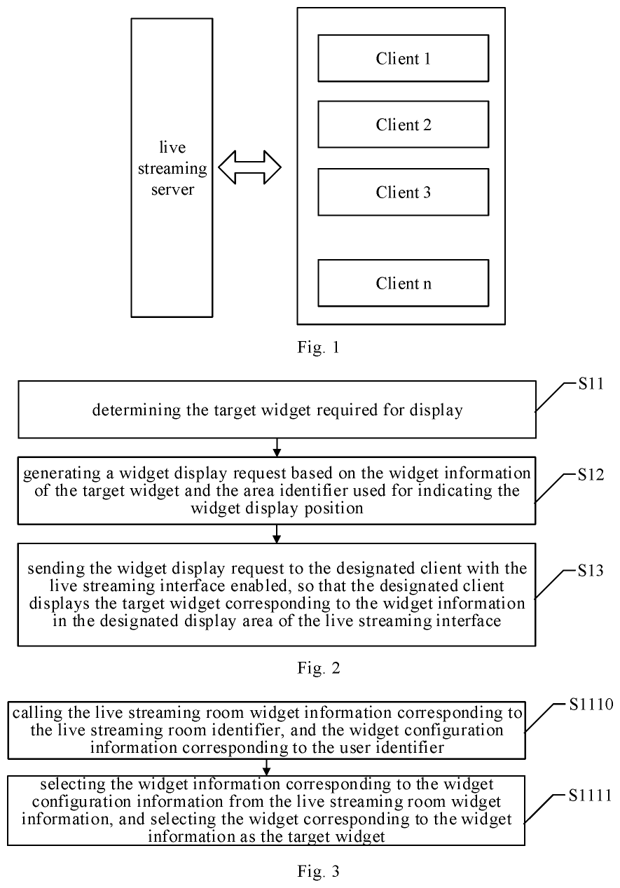

FIG. 1 is a schematic diagram of an application scenario of a widget display method according to an exemplary embodiment. The application scenario includes at least a live streaming server and multiple clients. The client may be a host client or a viewer client. The live streaming server is used to realize forwarding and caching of live messages between the host client and the viewer client, between the viewer client and the host client, or between the viewer clients, and logic processing of widgets in the live streaming room, etc. The live streaming server may run and maintain multiple live streaming rooms. During the live streaming process, the host may provide live contents to the viewer client with the respective live streaming interface enabled based on the host client with the live streaming interface enabled. Alternatively, the viewer may send live streaming messages to other viewer clients or host client with the respective live streaming interface enabled based on the viewer client with the live streaming interface enabled. It should be noted that the client or the designated client mentioned in embodiments of the present disclosure may be a host client and a viewer client, which is not limited in embodiments of the present disclosure. In some embodiments, the live streaming server may be an independent server, or may be composed of multiple sub-servers. The client may be, but is not limited to, a smart phone, an IPAD, a notebook, a wearable device, etc., which is not limited in embodiments of the present disclosure.

Based on the foregoing contents, the widget display method, apparatus, electronic device and computer storage medium provided in the present disclosure will be introduced below with reference to embodiments and the accompanying drawings, and the contents are as follows.

FIG. 2 is a flowchart of a widget display method according to an exemplary embodiment. The widget display method may be performed by a live streaming server, and specifically may be implemented by hardware and/or software in the live streaming server. Referring to FIG. 2, the widget display method provided by embodiments of the present disclosure may include the following steps.

In step S11, the target widget to be displayed is determined.

Depending on the type of live streaming room or live streaming platform, the type of widgets that may be displayed in the live streaming room (that is, the live streaming interface enabled on the client) is also different. For example, the target widget given in an embodiment of the present disclosure may be, but is not limited to, a lottery widget, an advertisement widget, an activity widget, and the like. For example, the lottery widget may be triggered when the host or background administrator sends live benefits to the viewers watching the live streaming. The client with the respective live streaming interface enabled may display the lottery widget, so that the viewer may click the widget to draw a lottery, thereby attracting other users to enter the live streaming room.

It should be noted that the live streaming server may pre-cache the interface area information of the live streaming room (including the association between the display area and the area identifier). Therefore, when the live streaming server determines the target widget, the widget information of the target widget and the area identifier used for indicating the widget display position are determined. The area identifier corresponds to at least one display area included in the live streaming interface. For example, depending on the size of the target widget, one target widget may occupy one or more display areas for display, which is not limited in embodiments of the present disclosure.

In some embodiments, the widget information may at least include, but is not limited to, a widget identifier and any one of widget position information (e.g., Content Delivery Network (CDN) address, etc.) for widget storage (e.g., widget icon, widget content, etc.), widget display priority information, and widget display time. The widget identifier may be a widget icon or a widget ID.

In some embodiments, according to different actual requirements, the way for determining the target widget is different. For example, the target widget may be determined according to the service requirements newly defined for the live streaming room by the developer of the live streaming room, or may be determined according to the live streaming room ID and user ID carried in the live streaming room entry request sent by the client. Alternatively, the target widget may be determined according to the widget display instruction sent by the host, etc. Embodiments of the present disclosure are not limited herein.

In some embodiments, the process of determining the target widget by the live streaming server is described by taking the live streaming room entry request as an example. The contents may include steps S110 and S111.

In step S110, a live streaming room entry request is received, where the live streaming room entry request carries a live streaming room identifier and a user identifier.

In step S111, the target widget is determined according to the live streaming room identifier and the user identifier.

In some embodiments, the live streaming room entry request may be initiated by a user with a live streaming room account when logging in to the live streaming room with the live streaming room account, or may be initiated when entering the live streaming room as a guest. The live streaming room identifier may be a live streaming room ID or a host ID, etc. The user identifier may be a user account, user identity information, and the like. It should be noted that there may be one or more target widgets determined according to the live streaming room identifier and the user identifier. In actual implementations, when there are multiple target widgets, a widget list may be generated according to the determined multiple target widgets.

As shown in FIG. 3, in an embodiment of the present disclosure, the step of determining the target widget according to the live streaming room identifier and the user identifier described in S111 may include sub-steps S1110 and S1111.

In sub-step S1110, the live streaming room widget information corresponding to the live streaming room identifier, and the widget configuration information corresponding to the user identifier are called.

In sub-step S1111, the widget information corresponding to the widget configuration information is selected from the live streaming room widget information, and the widget corresponding to the widget information is selected as the target widget.

It can be understood that the live streaming room widget information corresponding to the live streaming room identifier refers to the widget information of all the widgets that may be displayed in the live streaming interface preset by the background management personnel for the live streaming room. Different users may have different live viewing requirements. Therefore, in an embodiment of the present disclosure, the widget may be sent individually according to the live viewing requirements of different users. For example, based on the widget configuration information pre-configured by different users to meet their own needs, the respective widget information may be selected from multiple live streaming room widget information, and the widget corresponding to the widget information may be used as the target widget.

It should be noted that when the user corresponding to the user identifier is a newly registered user or other users who are configuring the widget information, the widget configuration information mentioned above may be empty. That is, the widget information corresponding to the widget configuration information acquired from the live streaming room widget information is zero. At this time, in order to ensure the live streaming experience of the new user, the widget that meets the user's preferences may be recommended as the target widget according to the personal information (such as age, gender, hobbies, etc.) of the new user generated during registration.

In some embodiments, for the method given in the aforementioned steps S110 to S111, the live streaming server may implement delivery and processing of information such as live streaming room data and widget display request through the API interface when the user enters the live streaming room. Even through a user needs to have a persistent connection, the persistent connection service does not need to deal with the logic related to widget display. This helps to reduce the pressure of the persistent connection service and enable the persistent connection service to prioritize processing the connection-related logic.

In step S12, a widget display request is generated based on the widget information of the target widget and the area identifier used for indicating the widget display position.

The widget display request generated based on the widget information may include all the information of the target widget, so that the client may obtain the target widget by parsing the widget display request, thereby realizing display of the target widget. However, considering that the lottery widget, advertisement widget, activity widget, etc. have a large volume, in an embodiment of the present disclosure, the widget display request may be generated based on the widget information such as widget identifier and widget storage position, so as to avoid sending the target widget directly based on the widget display request and thereby avoid problems such as a large waste of network resources and low link utilization.

In some embodiments, the widget storage position may be a position designated by the live streaming server, or may be a position determined through negotiation between the live streaming server and the client, which is not limited in embodiments of the present disclosure. In addition, a widget display request may include widget information and area identifier corresponding to one target widget, or may simultaneously include multiple widget information and area identifiers corresponding to multiple target widgets, which are not limited in embodiments of the present disclosure.

In step S13, the widget display request is sent to the designated client with the live streaming interface enabled, so that the designated client displays the target widget corresponding to the widget information in the designated display area of the live streaming interface.

The designated display area corresponds to the area identifier, and the designated display area corresponds to at least one display area in the live streaming interface. In addition, the designated client may be a host client or a viewer client, which is not limited in embodiments of the present disclosure.

In the aforementioned steps S11 to S13, the display logic (such as display area, widget information, etc.) of the target widget is processed by the live streaming server, and the widget display request is generated and sent to the client for display, so that the client only needs to display the widget according to the widget display logic contained in the received widget display request. This effectively reduces the service processing pressure of the client and realizes the dynamic delivery and configuration of the live streaming room widget. At the same time, even for the display of service widgets corresponding to new services, no need is required for the client to develop widgets, which effectively saves the client development cost.

Further, based on the above descriptions from step S11 to step S13, even for a widget that has been delivered or displayed on the client, the live streaming server may also update the widget (such as widget withdrawal, widget modification, etc.) to achieve flexible processing of the widget and avoid There is a problem in the related art that once the client version is released, no change can be made.

For example, in some embodiments, in the case where the target widget is a widget to be changed that has been sent to a designated client but needs to be changed in widget information, the step of generating the widget display request based on the widget information of the target widget and the area identifier used for indicating the widget display position in the aforementioned step S12 may include: generating the widget display request based on the widget information of the target widget, the area identifier for indicating the widget display position, and the preset update identifier for representing a widget change.

The preset update identifier may be flexibly designed according to requirements. For example, the preset update identifier may be a single character (such as 0, 1, etc.) or a string including multiple characters (such as 01, 1a, etc.). In actual implementations, the preset update identifier may be located at a designated position of the widget display request, so that the client may detect and read the preset update identifier based on the widget display request.

In some embodiments, according to the widget display methods given in steps S11 to S13, in the case where the live streaming server generates a widget display request for different services, the widget display request may use, but is not limited to, for example, a unified signaling format such as “CommonWidgetSignal[ ]”. With the above method, when performing service expansion and widget display, the live streaming server does not need to define signaling separately for different services. This is conducive to the expansion of different service widgets, effectively reduces the development cost and the deployment cost of services corresponding to different widgets, and avoids a lot of repetitive efforts.

In some embodiments, the widget display method may further include the step of dividing the live streaming interface into areas, and this includes steps S14 to S16.

In step S14, in response to the interface division operation initiated based on the live streaming interface, the live streaming interface is divided to obtain a plurality of display areas for widget display.

In step S15, an area identifier is added to each display area, and the display area with the area identifier added is saved in association with the area identifier.

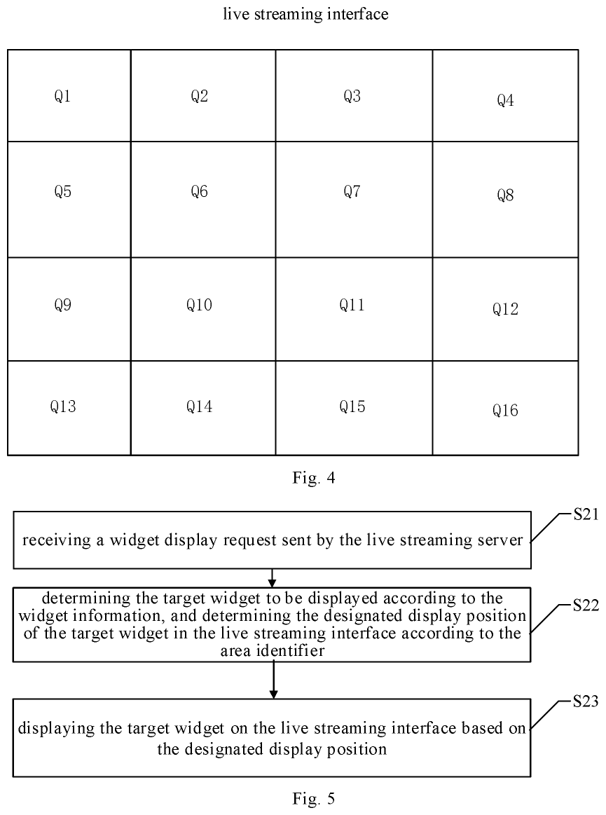

Reference may be made to FIG. 4, the live streaming interface may be divided, but not limited to, the division shown in FIG. 4, and each display area may be provided with a respective area identifier (such as number, letter, etc.) for generation of the widget display request. It should be noted that the number, size, etc. of the display area may be set as required, which is not limited by embodiments of the present disclosure.

In step S16, the interface area information is generated based on the display area and the area identifier saved in association with each other, and the interface area information is sent to the client with the live streaming interface enabled.

The live streaming server sends the interface area information to the client through S16 for storage by the client, so that the client may display the target widget at a designated position according to the area identifier included in the received widget display request.

Through implementations of the aforementioned step S14 to step S16, while displaying a widget, the live streaming server may control and send the widget configuration of each service widget uniformly in the background, thereby reducing the processing pressure of the client.

The following can be seen from the widget display method provided by embodiments of the present disclosure.

(1) After processing the display logic (such as display area, widget information, etc.) of the target widget by the live streaming server, it is sent to the client in the form of a widget display request for display, so that the client only needs to display the widget according to the widget display logic contained in the received widget display request. This effectively reduces the service processing pressure of the client, and realizes the dynamic delivery and configuration of widgets in the live streaming room. At the same time, even for the display of service widgets corresponding to new services, no need is required for the client to develop widgets, which effectively saves the client development cost.

(2) In the aforementioned widget display method provided by embodiments of the present disclosure, even for widgets that have been delivered or displayed on the client, the live streaming server may also perform widget update (such as widget withdrawal, widget modification, etc.) therefore. This helps to realize flexible processing of widgets and avoid a problem in related technologies that the client version cannot be changed once released.

FIG. 5 is a flowchart of a widget display method according to an exemplary embodiment. The widget display method may be executed by a client (e.g., a host client or a viewer client), and may be specifically implemented by hardware and/or software in the client. With reference to FIG. 5, the widget display method may include the following steps.

In step S21, a widget display request sent by the live streaming server is received.

The widget display request received by the client may carry widget information of the target widget to be displayed and an area identifier. The area identifier corresponds to at least one display area included in the live streaming interface. In addition, a widget display request may include widget information and area identifier corresponding to one target widget, or may simultaneously include multiple widget information and area identifiers corresponding to multiple target widgets, which are not limited in embodiments of the present disclosure.

It should be noted that regarding the type of the target widget, widget information, area identifier, etc. involved in an embodiment of the present disclosure, references may be made to the respective description in the previous embodiment, and an embodiment of the present disclosure will not be repeated here.

In step S22, the target widget to be displayed is determined according to the widget information, and the designated display position of the target widget in the live streaming interface is determined according to the area identifier.

According to different widget information, various ways may be provided to determine the target widget. For example, if the widget information includes all the contents of the target widget, the client may directly analyze the widget information to obtain the target widget.

For another example, if the widget information includes at least the widget identifier and the widget position information (such as CDN address, etc.) used for widget storage, the client may obtain the target widget corresponding to the widget identifier at the designated position corresponding to the widget position information.

It should be noted that, in actual implementations, the target widget may be determined in either of the above two ways, but the present disclosure is not limited thereto. In addition, in the case of determining the designated display position, the client may preset the respective relationship between the area identifier and each display area included in the live streaming interface, so that the client may determine the designated display position of the target widget in the live streaming interface based on the area identifier included in the widget display request.

In some embodiments, before the step of receiving a widget display request sent by the live streaming server described in step S21, the widget display method may further include: receiving interface area information sent by the live streaming server, where the interface area information includes the display area and the area identifier saved in association with each other; and saving the interface area information. It should be noted that, regarding the acquisition process of the interface area information, reference may be made to the relevant description in the foregoing embodiment, and an embodiment of the present disclosure will not be repeated here.

In step S23, the target widget is displayed on the live streaming interface based on the designated display position.

It should be noted that in the case of displaying the target widget, in response to the widget information also including widget display priority information, widget display time, etc., the client needs to display the target widget according to the widget display priority information and the widget display time. For example, if the current time is 9:30 on Dec. 9, 2019, but the widget information includes a widget display time of 19:30 on Dec. 9, 2019, then the client can only display the target widget, at 19:30 on December 2019, at the designated display position in the live streaming interface.

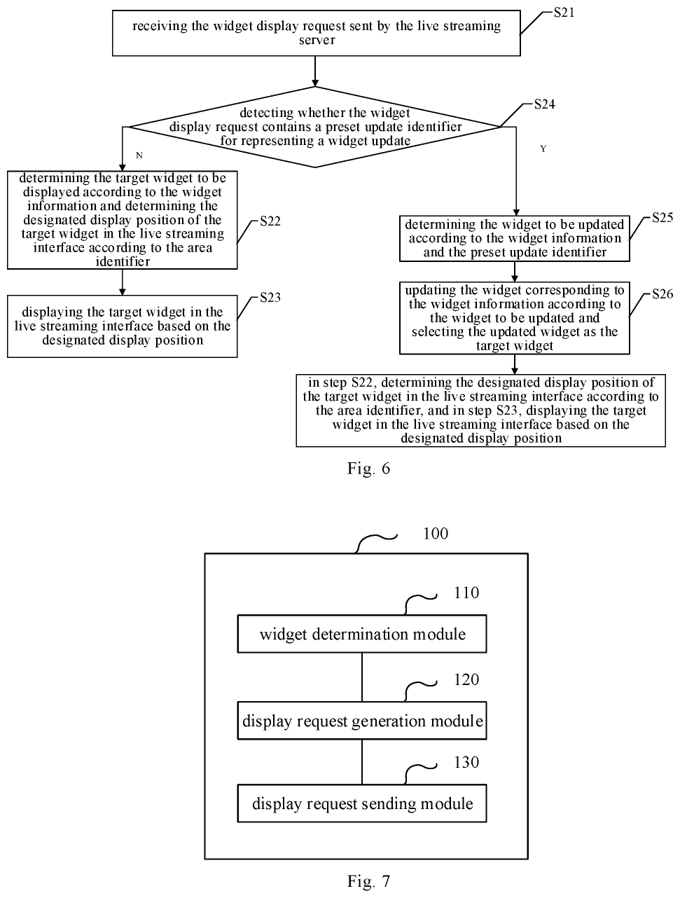

In some embodiments, considering that the widget display request may be a widget display request corresponding to a target widget to be displayed that is first delivered to the client, or a widget update request for updating a widget already delivered to the client, then in the case of receiving the widget display request, as shown in FIG. 6, the client may perform the step of widget request detection on the widget display request, and this may include steps S24 to S26, the contents of which are as follows.

In step S24, it is detected whether the widget display request contains a preset update identifier for representing the widget update. If the preset update identifier is not included, step S22 is performed; and otherwise, steps S25 and S26 are performed.

In step S25, the widget to be updated is determined according to the widget information and the preset update identifier;

In step S26, the widget corresponding to the widget information is updated according to the widget to be updated, the updated widget is selected as the target widget, and the step S22 of determining the designated display position of the target widget in the live streaming interface according to the area identifier and the step S23 are performed.

It should be noted that when updating the widget, one may only update the widget information that has changed in the widget corresponding to the widget identifier, or one may directly replace the widget corresponding to the widget identifier with the target widget (that is, the widget to be updated). The disclosed embodiments are not limited herein.

Based on the above descriptions from steps S24 to S26, it can be seen that even for a widget that has been delivered or displayed on the client, the live streaming server may update them by sending widget display requests (such as widget withdrawal, widget modification, etc.). This helps to realize dynamic configuration of the widget, avoiding a problem in the related technology that the client version cannot be changed once it is released.

In addition, in some embodiments, if the live streaming server needs to disable the widget displayed in the live streaming room, it may send a widget display request with empty content to the client. Then, in the case that the widget display request received by the client does not include the widget information, the client may perform a widget display disable operation for each widget displayed in the live streaming interface, so as to disable the widget that has been displayed or will be displayed in the live streaming interface.

In some embodiments, before performing the step S21 of receiving the widget display request sent by the live streaming server, the widget display method may further include: in response to the live streaming room entry operation initiated by a user, sending a live streaming room entry request carrying the user identifier and the live streaming room identifier of the live streaming room to be entered to the live streaming server, so that the live streaming server generates the widget display request based on the user identifier and the live streaming room identifier.

The live streaming room identifier may be a live streaming room ID or a host ID, etc. The user identifier may be a user account, user identity information, and the like.

The following can be seen from the widget display method provided by embodiments of the present disclosure.

(1) After processing the display logic (such as display area, widget information, etc.) of the target widget by the live streaming server, it is sent to the client in the form of a widget display request for display, so that the client only needs to display the widget according to the widget display logic contained in the received widget display request. This effectively reduces the service processing pressure of the client, and realizes dynamic delivery and configuration of widgets in the live streaming room. At the same time, even for the display of service widgets corresponding to new services, no need is required for the client to develop widgets, which effectively saves the client development cost.

(2) In the aforementioned widget display method provided by embodiments of the present disclosure, even for widgets that have been delivered or displayed on the client, the live streaming server may also perform widget update (such as widget withdrawal, widget modification, etc.). This helps to realize flexible processing of widgets and avoid the problem in related technologies that the client version cannot be changed once released.

Reference may be made to FIG. 1 again. In the following, a brief description is provided of the widget display process provided in the present disclosure by using a client and a live streaming server to form the live system shown in FIG. 1, and the contents are as follows.

(1) In response to the interface division operation initiated based on the live streaming interface, the live streaming server divides the live streaming interface to obtain multiple display areas for widget display, adds an area identifier to each display area, and save the display area with the area identifier added in association with the area identifier.

(2) The live streaming server generates interface area information based on the display area and the area identifier saved in association with each other, and sends the interface area information to the client for saving.

(3) The live streaming server determines the target widget that needs to be displayed in the live streaming interface enabled in the client.

(4) The live streaming server generates a widget display request based on the widget information of the target widget and the area identifier used for indicating the widget display position, and sends the widget display request to the client.

(5) When the client receives the widget display request sent by the live streaming server, it detects whether the widget display request contains a preset update identifier for representing the widget update. If not, the process goes to (6); and if so, the process goes to (7).

(6) The client determines the target widget according to the widget information contained in the widget display request, and determines the designated display position according to the area identifier. The client displays the target widget in the live streaming interface based on the designated display position.

(7) The client determines the widget to be updated according to the widget information and the preset update identifier. The client updates the widget corresponding to the widget information according to the widget to be updated, selects the updated widget as the target widget, determines the designated display position of the target widget in the live streaming interface according to the area identifier, and displays the target widget at the designated display position in the live streaming interface based on the designated display position.

It should be noted that the steps given above have been described in detail in embodiments of the present disclosure, and are not repeated here. In addition, the widget display process applied to the live streaming system given in embodiments of the present disclosure may be, but is not limited to, the process given above. For example, the order of each process may be exchanged, or the actual interaction process may be more or less, etc., which are not repeated in embodiments of the present disclosure.

FIG. 7 is a block diagram of a widget display apparatus 100 according to an exemplary embodiment, and the widget display apparatus 100 may be applied to a live streaming server. Referring to FIG. 7, the widget display apparatus 100 includes a widget determination module 110, a display request generation module 120 and a display request sending module 130.

The widget determination module 110 is configured to determine the target widget to be displayed. In some embodiments, the widget determination module 110 may include an entry request receiving unit and a widget determination unit.

The entry request receiving unit is configured to receive a live streaming room entry request, where the live streaming room entry request carries the live streaming room identifier and the user identifier.

The widget determination unit is configured to determine the target widget according to the live streaming room identifier and the user identifier. In some embodiments, the widget determination unit includes a information calling subunit and a widget selection subunit.

The information calling subunit is configured to call the live streaming room widget information corresponding to the live streaming room identifier, and to call the widget configuration information corresponding to the user identifier.

The widget selection subunit is configured to select widget information corresponding to the widget configuration information from the live streaming room widget information, and select the widget corresponding to the widget information as the target widget.

The display request generation module 120 is configured to generate a widget display request based on widget information of the target widget and an area identifier used for indicating the display widget position. The area identifier corresponds to at least one display area included in the live streaming interface. The widget at least includes the widget identifier, and at least one of widget position information for widget storage, widget display priority information, and widget display time.

In some embodiments, when the target widget is a widget to be changed that has been sent to a designated client but needs to be changed in widget information, the display request generation module is further configured to generate the widget display request based on the widget information of the target widget, the area identifier for indicating the widget display position, and a preset update identifier used for representing a widget change.

The display request sending module 130 is configured to send a widget display request to a designated client with a live streaming interface enabled, so that the designated client displays the target widget corresponding to the widget information in a designated display area of the live streaming interface, where the designated display area corresponds to the area identifier.

In some embodiments, apparatus 100 may further include: an operation response module, configured to, in response to an interface division operation initiated based on the live streaming interface, to obtain a plurality of display areas for widget display by dividing the live streaming interface; an area information saving module, configured to add area identifier to each display area, and save the display area with the area identifier added in association with the area identifier; and an area information sending module, configured to generate interface area information based on the display area and the area identifier saved in association with each other, and send the interface area information to the client having the live streaming interface enabled.

Regarding the apparatus 100 in an embodiment of the present disclosure, the specific mode in which each module performs operations has been described in detail in an embodiment of the method, which will not be described in detail here.

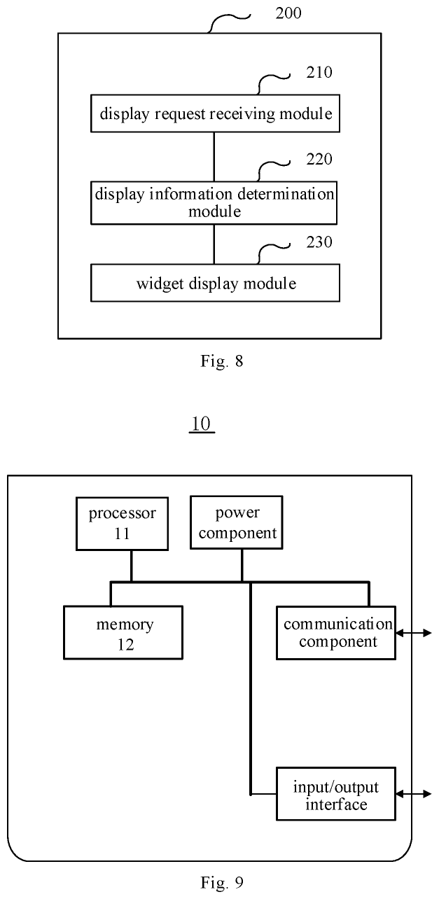

FIG. 8 is a block diagram of a widget display apparatus 200 according to an exemplary embodiment, and the widget display apparatus 200 may be applied to a client. With reference to FIG. 8, the widget display apparatus 200 includes a display request receiving module 210, a display information determination module 220 and a widget display module 230.

The display request receiving module 210 is configured to receive a widget display request sent by the live streaming server, where the widget display request carries widget information and an area identifier, and the area identifier corresponds to at least one display area included in the live streaming interface.

The display information determination module 220 is configured to determine the target widget to be displayed according to the widget information, and to determine the designated display position of the target widget in the live streaming interface according to the area identifier. In some embodiments, the display information determination module is specifically configured to, when the widget information includes at least the widget identifier and the widget position information for widget storage, acquire the target widget corresponding to the widget identifier at the designated position corresponding to the widget position information.

The widget display module 230 is configured to display the target widget in the live streaming interface based on the designated display position.

In some embodiments, according to some possible implementations, the apparatus 200 may further include an update identification detection module. The update identification detection module includes: an identification detection unit, configured to, when the widget display request does not contain a preset update identifier for representing a widget updata, determine the target widget according to the widget information, and determine the designated display position of the target widget in the live streaming interface according to the area identifier.

In some embodiments, the update identification detection module may further include: an update information acquisition unit, configured to, when the widget display request includes the preset update identification, acquire the widget to be updated corresponding to the widget identifier at a designated position corresponding to the widget position information; and a widget update unit, configured to replace the widget corresponding to the widget identifier with the widget to be updated, and select the widget to be updated after the replacement as the target widget to be displayed.

In some embodiments, apparatus 200 may also include: an entry request sending module, configured to, in response to the live streaming room entry operation initiated by a user, send the live streaming room entry request carrying the user identifier and the live streaming room identifier of the live streaming room to be entered to the live streaming server, so that the live streaming server generates the widget display request based on the user identifier and the live streaming room identifier.

In some embodiments, the apparatus 200 may further include: a display disable module, configured to perform a widget display disable operation for each widget displayed in the live streaming interface when the received widget display request does not contain the widget information.

In some embodiments, the apparatus 200 may further include: an area information receiving module, configured to: receive the interface area information sent by the live streaming server, where the interface area information includes the display area and the area identifier stored in association with each other; and save the interface area information.

Regarding the apparatus 200 in an embodiment of the present disclosure, the specific mode in which each module performs operations has been described in detail in an embodiment of the method, which will not be described in detail here.

Reference may be made to FIG. 9, which is a block diagram of an electronic device 10 according to an exemplary embodiment. The electronic device 10 may at least include a processor 11 and a memory 12 for storing instructions executable by the processor 11. The processor 11 is configured to execute instructions to implement all or part of the steps of the widget display method in the above-mentioned embodiments. It should be noted that, according to different application scenarios, the electronic device 10 provided by embodiments of the present disclosure may be the aforementioned live streaming server, or may be a client, such as a host client or a viewer client, which is not limited by embodiments of the present disclosure.

The processor 11 and the memory 12 are directly or indirectly electrically connected to realize data transmission or interaction. For example, these elements may be electrically connected to each other through one or more communication buses or signal lines.

The processor 11 is used to read/write data or programs stored in the memory, and perform respective functions.

The memory 12 is configured to store programs or data, such as instructions executable by the processor 110. The memory 12 may be, but not limited to, random access memory (RAM), read only memory (ROM), programmable read only memory (PROM), erasable programmable read only memory (EPROM), Electrical Erasable Programmable Read Only Memory (EEPROM), and so on.

In some embodiments, the electronic device 10 may also include a power component, a multimedia component, an audio component, an input/output (I/O) interface, a sensor component, a communication component, and the like.

The power component provides power to various components of electronic device 10. The power component may include a power management system, one or more power sources, and other components associated with generating, managing, and distributing power to the electronic device 10.

The multimedia component includes a screen that provides an output interface between the electronic device 10 and the user. In some embodiments, the screen may include a liquid crystal display (LCD) and a touch panel (TP). If the screen includes a touch panel, the screen may be implemented as a touch screen to receive an input signal from the user. The touch panel includes one or more touch sensors to sense touch, swipe, and gesture on the touch panel. A touch sensor may sense not only the boundary of a touch or swipe action, but also the duration and pressure associated with the touch or swipe action. In some embodiments, the multimedia component includes a front camera and/or a rear camera. When the electronic device 10 is in an operation mode, such as a shooting mode or a video mode, the front camera and/or the rear camera may receive external multimedia data. Each of the front and rear cameras may be a fixed optical lens system or have a focal length and optical zooming capability.

The audio component is configured to output and/or input an audio signal. For example, the audio component includes a microphone (MIC) that is configured to receive an external audio signal when the electronic device 10 is in an operation mode, such as calling mode, recording mode, and voice recognition mode. The received audio signal may be stored in the memory 12 or transmitted via the communication component. In some embodiments, the audio component further includes a speaker for outputting an audio signal.

The I/O interface provides an interface between the processing component and a peripheral interface module. The above-mentioned peripheral interface module may be a keyboard, a click wheel, a button, and the like. These buttons may include, but are not limited to: home button, volume button, start button, and lock button.

The sensor component includes one or more sensor for providing various aspects of status assessment of the electronic device 10. For example, the sensor component may detect the on/off state of the electronic device 10, the relative positioning of the components, such as display and keypad of the electronic device 10. The sensor component may also detect the position change of the electronic device 10 or a component of the electronic device 10, the presence or absence of the user's contact with the electronic device 10, the orientation or acceleration/deceleration of the electronic device 10 and the temperature change of the electronic device 10. The sensor component may include a proximity sensor, configured to detect the presence of nearby objects in the absence of any physical contact. The sensor component may also include a light sensor, such as a CMOS or CCD image sensor, for use in imaging applications. In some embodiments, the sensor component may also include an acceleration sensor, a gyroscope sensor, a magnetic sensor, a pressure sensor, or a temperature sensor.

The communication component is configured to facilitate wired or wireless communication between the electronic device 10 and other devices. The electronic device 10 may access wireless networks based on communication standards, such as WiFi, carrier networks (e.g., 2G, 3G, 4G, or 5G), or a combination thereof. In one exemplary embodiment, the communication component receives broadcast signals or broadcast related information from an external broadcast management system via a broadcast channel. In one exemplary embodiment, the communication component further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an exemplary embodiment, the electronic device 10 may be implemented by one or more application specific integrated circuits (ASICs), digital signal processors (DSPs), digital signal processing devices (DSPDs), programmable logic devices (PLDs), field programmable gate arrays (FPGA), controllers, microcontrollers, microprocessors or other electronic components, for performing the above method.

It should be understood that the structure shown in FIG. 9 is only a schematic structural diagram of the electronic device 10, and the electronic device 10 may further include more or less components than those shown in FIG. 9, or have different configurations from that shown in FIG. 9. Each component shown in FIG. 9 may be implemented in hardware, software, or a combination thereof.

In an exemplary embodiment, a non-transitory computer-readable storage medium including instructions, such as a memory 12 including instructions, is also provided. The instructions may be executed by the processor 11 of the electronic device 10 to complete the above-mentioned widget display method. For example, the non-transitory computer-readable storage medium may be ROM, random access memory (RAM), CD-ROM, magnetic tape, floppy disk, optical data storage device, and the like.

In an exemplary embodiment, there is also provided a computer program product, comprising at least one non-transitory computer-readable medium storing instructions translatable by at least one processor, for implementing the widget display apparatus in the foregoing embodiments.

Other embodiments of the present disclosure will readily occur to those skilled in the art upon consideration of the specification and practice of the content disclosed herein. The present disclosure is intended to cover any variations, uses, or adaptations of the present disclosure that follow the general principle of the present disclosure and include common general knowledge or techniques in the technical field not disclosed by the present disclosure. The specification and examples are to be regarded as exemplary only, with the true scope and spirit of the present disclosure being indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

What is claimed:

1. A widget display method, applied to a live streaming server and comprising:
determining a target widget required for display;
generating a widget display request based on widget information of the target widget and an area identifier for indicating a widget display position, wherein the area identifier corresponds to at least one display area comprised in a live streaming interface; and
sending the widget display request to a designated client with the live streaming interface enabled, so that the designated client displays the target widget corresponding to the widget information in a designated display area of the live streaming interface, wherein the designated display area corresponds to the area identifier.

2. The widget display method according to claim 1, wherein said determining the target widget required for display comprises:
receiving a live streaming room entry request, wherein the live streaming room entry request carries a live streaming room identifier and a user identifier; and
determining the target widget according to the live streaming room identifier and the user identifier.

3. The widget display method according to claim 2, wherein said determining the target widget according to the live streaming room identifier and the user identifier comprises:
calling live streaming room widget information corresponding to the live streaming room identifier and widget configuration information corresponding to the user identifier; and
selecting widget information corresponding to the widget configuration information from the live streaming room widget information, and selecting a widget corresponding to the widget information as the target widget.

4. The widget display method according to claim 1, wherein, in the case that the target widget is a widget to be changed that has been sent to the designated client but needs to be changed in widget information, said generating the widget display request based on the widget information of the target widget and the area identifier for indicating the widget display position, comprises:
generating the widget display request based on the widget information of the target widget, the area identifier for indicating the widget display position, and a preset update identifier for representing a widget change.

5. The widget display method according to claim 1, wherein the widget information comprises a widget identifier and at least one of widget position information for widget storage, widget display priority information, and widget display time.

6. The widget display method according to claim 1, wherein the method further comprises:
in response to an interface division operation initiated based on the live streaming interface, obtaining a plurality of display areas for widget display by dividing the live streaming interface;
adding an area identifier to each display area, and storing the display area with the area identifier added in association with the area identifier; and
generating interface area information based on the display area and the area identifier stored in association with each other, and sending the interface area information to a client with the live streaming interface enabled.

7. A widget display method, applied to a client and comprising:
receiving a widget display request sent by a live streaming server, wherein the widget display request carries widget information and an area identifier, and the area identifier corresponds to at least one display area comprised in a live streaming interface;
determining a target widget to be displayed according to the widget information, and determining a designated display position of the target widget in the live streaming interface according to the area identifier; and
displaying the target widget in the live streaming interface based on the designated display position.

8. The widget display method according to claim 7, wherein said determining the target widget according to the widget information comprises:
in response to the widget information at least comprising a widget identifier and widget position information for widget storage, acquiring the target widget corresponding to the widget identifier at a designated position corresponding to the widget position information.

9. The widget display method according to claim 7, wherein the method further comprises:
in response to the widget display request comprising no preset update identifier for representing a widget update, performing steps of determining the target widget according to the widget information, and determining the designated display position of the target widget in the live streaming interface according to the area identifier.

10. The widget display method according to claim 9, wherein the method further comprises:
in response to the widget display request comprising the preset update identifier, determining a widget to be updated according to the widget information and the preset update identifier;
updating a widget corresponding to the widget information according to the widget to be updated, selecting the updated widget as the target widget, and performing steps of determining the designated display position of the target widget in the live streaming interface according to the area identifier, and displaying the target widget in the live streaming interface based on the designated display position.

11. The widget display method according to claim 7, wherein the method further comprises:
in response to a live streaming room entry operation initiated by a user, sending a live streaming room entry request carrying a user identifier and a live streaming room identifier of a live streaming room to be entered to the live streaming server, so that the live streaming server generates the widget display request based on the user identifier and the live streaming room identifier.

12. The widget display method according to claim 7, wherein the method further comprises:
in response to the received widget display request comprising no widget information, performing a widget display disable operation for each widget displayed in the live streaming interface.

13. The widget display method according to claim 7, wherein the method further comprises:
receiving interface area information sent by the live streaming server, wherein the interface area information comprises the display area and the area identifier saved in association with each other; and
saving the interface area information.

14. An electronic device, comprising:
a processor; and
a memory, configured to store instructions executable by the processor,
wherein the processor is configured to execute the instructions to implement steps of:
determining a target widget required for display;
generating a widget display request based on widget information of the target widget and an area identifier for indicating a widget display position, wherein the area identifier corresponds to at least one display area comprised in a live streaming interface; and
sending the widget display request to a designated client with the live streaming interface enabled, so that the designated client displays the target widget corresponding to the widget information in a designated display area of the live streaming interface, wherein the designated display area corresponds to the area identifier.

15. The widget display method according to claim 2, wherein the widget information comprises a widget identifier and at least one of widget position information for widget storage, widget display priority information, and widget display time.

16. The widget display method according to claim 3, wherein the widget information comprises a widget identifier and at least one of widget position information for widget storage, widget display priority information, and widget display time.

17. The widget display method according to claim 4, wherein the widget information comprises a widget identifier and at least one of widget position information for widget storage, widget display priority information, and widget display time.

18. The widget display method according to claim 2, wherein the method further comprises:
in response to an interface division operation initiated based on the live streaming interface, obtaining a plurality of display areas for widget display by dividing the live streaming interface;
adding an area identifier to each display area, and storing the display area with the area identifier added in association with the area identifier; and
generating interface area information based on the display area and the area identifier stored in association with each other, and sending the interface area information to a client with the live streaming interface enabled.

19. The widget display method according to claim 3, wherein the method further comprises:
in response to an interface division operation initiated based on the live streaming interface, obtaining a plurality of display areas for widget display by dividing the live streaming interface;
adding an area identifier to each display area, and storing the display area with the area identifier added in association with the area identifier; and
generating interface area information based on the display area and the area identifier stored in association with each other, and sending the interface area information to a client with the live streaming interface enabled.

20. The widget display method according to claim 4, wherein the method further comprises:
in response to an interface division operation initiated based on the live streaming interface, obtaining a plurality of display areas for widget display by dividing the live streaming interface;
adding an area identifier to each display area, and storing the display area with the area identifier added in association with the area identifier; and
generating interface area information based on the display area and the area identifier stored in association with each other, and sending the interface area information to a client with the live streaming interface enabled.
